(19) United States
(12) Patent Application Publication
(10) Pub. No.: US 2002/0043384 A1
(43) Pub. Date: Apr. 18, 2002

(54) Aerator tow bar

(76) Inventor: Gerald D. Thompson, Kennett Square, PA (US)

Correspondence Address: Robert S. Lipton, Esquire, LIPTON, WEINBERGER & HUSICK, 201 North Jackson Street, P.O. Box 934, Media, PA, 19063, US

(21) Appl. No.: 09/905,029

(22) Filed: Jul. 13, 2001

Related U.S. Application Data
(60) Provisional application No. 60/218,082, filed on Jul. 13, 2000.

(51) Int. Cl. A01B 15/14

(52) U.S. Cl. 172/776

(57) ABSTRACT

The invention is a vehicle tow bar for self-powered aerators for grassy areas, such as golf courses. U-shaped members attached to the tow bar slide over the front axle housing of the self-powered aerator and allow the aerator to be towed swiftly from place to place using a tow vehicle, speeding the golf course aeration process. A corresponding method also is provided.

### CROSS REFERENCE TO RELATED APPLICATION

This application claims the benefit of U.S. Provisional Application No. 60/218,082 filed Jul. 13, 2000.

### BACKGROUND OF THE INVENTION

1. Field of the Invention

This invention relates to a self-propelled aerator, particularly to a type having at least one axle and used for performing maintenance of grassy areas at golf courses, and, more particularly, to a tow bar for a self-propelled aerator.

2. Description of the Prior Art

Tow bars are well known in the art and are of varied types for use with distinct types of vehicles. Examples of tow bars for particular use with recreational vehicles include those disclosed in U.S. Pat. No. 5,873,595 issued Feb. 23, 1999 and in U.S. Pat. No. 5,516,140 issued May 14, 1996, both to Hinte; in U.S. Pat. No. 5,429,382 issued Jul. 4, 1995 and U.S. Pat. No. 5,147,095 issued to Sep. 15, 1992, both to Duncan. Examples of tow bars for use with automobiles or trailers include those disclosed in U.S. Pat. No. 5,277,446 issued Jan. 11, 1994 to Hamel; in U.S. Pat. No. 5,240,273 issued Aug. 31, 1993 to Stead et al.; in U.S. Pat. No. 4,958,847 issued Sep. 25, 1990 to Williams; and in U.S. Pat. No. 4,147,373 issued Apr. 3, 1979 to Cully. An example of a tow bar for use with a snowmobile is disclosed in U.S. Pat. No. 3,797,846 issued Mar. 19, 1974 to Pevic. An example of an aircraft tow bar is disclosed in U.S. Pat. No. 3,829,131 issued Aug. 13, 1974 to Moore, Jr. Examples of tow bars for three-wheeled vehicles are disclosed in U.S. Pat. No. 4,736,963 issued Apr. 12, 1988 to Bettencourt and in U.S. Pat. No. 4,170,370 issued Oct. 9, 1979 to Schaefer.

However, these prior art devices are not particularly suitable for towing a piece of golf course maintenance equipment that is self-propelled and called variously an aerator or an aerifier. During the fall and again in the early spring, golf courses perform several maintenance operations to their greens and fairways to keep-the grass healthy and full. An important maintenance operation is called variously aeration or aerification, a process by which openings are made in the turf so that the underlying soil is exposed to the air and receives oxygen. To aerate their lawns, golf courses generally use a motorized unit of equipment called an aerifier or aerator. Although aerators can range in size, an ordinary golf course aerator is sized similarly to a riding lawn mower. Typically, it is a four-wheeled vehicle that may be self-propelled. Aerators that are not self-propelled are designed for use with a tractor and/or riding mower. Such aerators are typically mounted onto a hitch provided in the front of the tractor or riding mower and moved under the power of the tractor or mower. On the other hand, self-propelled aerators are typically gasoline powered and operated by a golf course technician operates who walks behind it and guides its direction. They are not engineered to be mounted onto the hitches provided on various tractors and riding mowers.

As a self-propelled aerator is guided over the lawn, an array of coring tines arranged in a specific pattern and of a certain width ranging from 4½ to 7 feet (1.37 to 2.13 m) punches holes into the turf, the depth of which typically from three to five inches (7.62 to 12.7 cm). Tine diameters vary from ¼ to ⅞ inch (0.6 to 2 cm). Typically, the array of tines is disposed around a wheel or wheels that are rolled over the area to be aerated.

Aerators are generally slow moving vehicles, with normal operating speeds between 3 to 5 miles per hour. Typical aerators of fairways and other large turf areas can aerate about 1.5 to 1.75 acres per hour and aeration acreage rates for rougher turf areas are lower.

Its slow pace, while required to thoroughly aerate a grassy area, limits the usefulness of an aerator during the biennial maintenance periods. Since greens and fairways are often separated by relatively large distances, transporting an aerator under its own power from one green or fairway to another can take more time than the aeration process itself. Consequently, aeration by self-propelled aerators can often take an unnecessarily long period of time, which results in inefficient use of labor and extra expense.

Therefore, it is (desirable to have a tow bar that can connect a self-propelled aerator to another vehicle that can transport the aerator between spread-out and distant turf areas on a golf course at speeds greater than at which the aerator operates.

### SUMMARY OF THE INVENTION

This invention provides a tow bar that is configured to be attached to a self-propelled aerator that has at least one wheel axle and to a powered vehicle that transports the self-propelled aerator at speeds greater than the aerator can attain under its own power and which reduces the lateral movement of the aerator during towing over uneven terrain. The invention also provides a method wherein a self-propelled aerator having at least one wheel axle is transported at speeds greater than under its own power by being attached to a powered towing vehicle and then having the towing vehicle transport it to a desired location.

It is a principal feature of the present invention to provide an aerator tow bar adapted to attach a towing vehicle to a self-propelled aerator having at least one wheel axle. Additionally, the present invention features a tow bar adapted to reduce the lateral movement of such an aerator as the towing vehicle transports it over uneven terrain or rough turf. Another feature of this invention is the provision of such a tow bar that is of simplified construction for economical manufacture, maintenance and repair.

It is also a principal feature of the invention to provide a method for towing a self-propelled aerator by: attaching the tow bar of this invention to a towing vehicle and to a self-propelled aerator having at least one wheel axle; and then transporting the aerator to the desired location.

An advantage of the present invention is that the self-propelled aerator may be transported to a desired location in the golf course at much greater speeds than under its power and thereby reduce the total time for aerating a golf course. The method of towing a self-propelled aerator has the advantage of increasing employee productivity, improving overall timely sequencing of equipment and personnel and thereby reducing the overall expense for performing golf course maintenance.

The foregoing and other advantages and features of this invention will appear from the following detailed description, taken in connection with the accompanying drawings.

### BRIEF DESCRIPTION OF THE DRAWINGS

FIG. 1 is a perspective view of the tow bar of the present invention.

FIG. 2 is a detail of the means for connecting the tow bar to a aerator.

FIG. 3 is a partial perspective view showing connection of the tow bar to the front axle housing of a self-propelled aerator.

FIG. 4 is a first alternative embodiment showing a clevis pin connection to a towing vehicle.

FIG. 5 is a second alternative embodiment showing a hook connection to a towing vehicle.

FIG. 6 is a third alternative embodiment showing a trailer hitch connection to a towing vehicle.

### DESCRIPTION OF THE PREFERRED EMBODIMENT

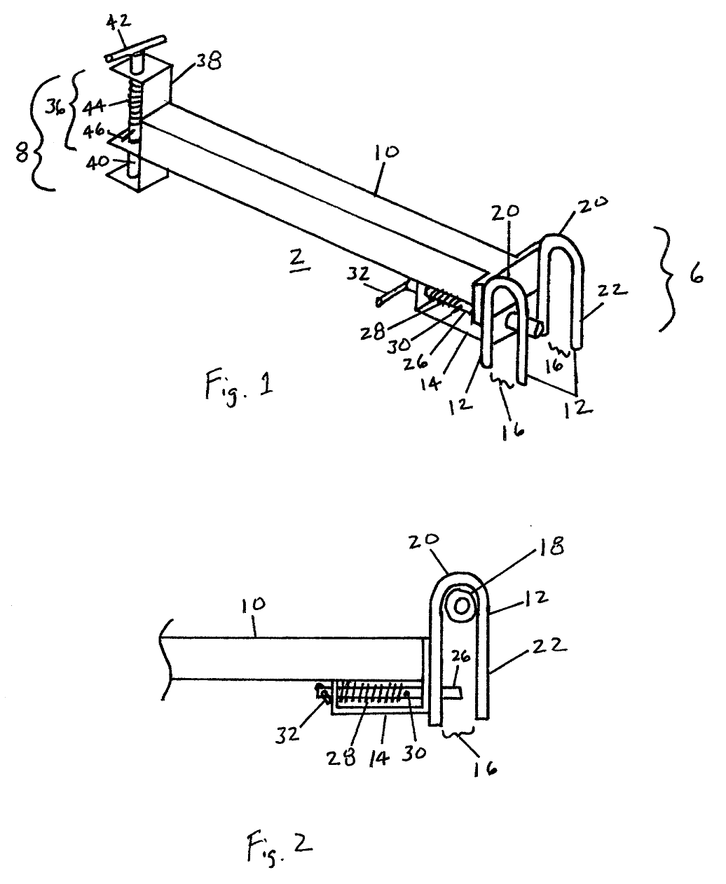

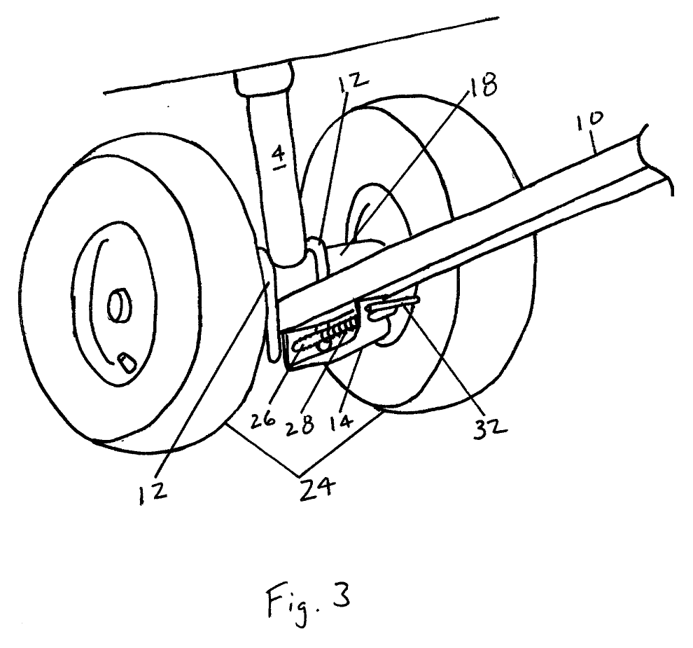

A vehicle tow bar 2 (FIG. 1) provides for releasable attachment to the front end of a self-propelled aerator 4 (FIG. 3) to be towed and to the rear end of a towing vehicle (not shown). Tow bar 2 comprises three distinct sections: the means 6 for attaching the tow bar 2 to the self-propelled aerator 4, the means 8 for attaching the tow bar 2 to the towing vehicle and the cross member 10 that connects these two means.

The means 6 for attaching the tow bar to the aerator 4 comprises two parallel U-shaped bars 12 and a spring mechanism 14. The U-shaped bars 12 define an axle-receiving opening 16 and are designed to slide over and past the axle housing 18 (FIG. 3) of the aerator 4 so that the curved portion 20 of the bars 12 rest on the axle housing 18. The U-shaped bars 12 are configured so that the straight portions 22 of the bars 12 extend several inches past the aerator axle housing 18. The U-shaped bars 12 are set apart from each other so as to slide over and rest onto the axle housing 18 between the two front wheels 24 of the aerator 4.

The U-shaped bars 12, and hence the tow bar 2, are secured to the aerator 4 by an aerator latch springbar 26. Initially, the aerator latch springbar 26 is urged into a first (closed) position by aerator latch spring 28 pressing against an aerator latch spring stop 30. Pulling aerater latch handle 32 causes the aerator latch springbar 26 to move away from the axle-receiving opening 16 to a second (open) position. The aerator latch spring stop 34 attached to the aerator latch springbar 26 presses against and compresses the aerator latch spring 28. Releasing the aerator latch handle 32 allows the aerator spring 28 to urge the aerator latch springbar 26 back to the first (closed) position.

In attaching the tow bar 2 to the aerator 4, the U-shaped bars 12 slide over the aerator axle housing 18 and the aerator latch handle 32 is pulled, thereby compressing the aerator latch spring 28 and moving aerator latch springbar 26 into the second (open) position. The U-shaped bars 12 are positioned so that the axle housing 18 passes into the axle receiving opening 16 and the U-shaped bars rest on the front wheel axle housing 18. Aerator latch handle 32 is released, thereby allowing aerator latch spring 28 to urge aerator latch springbar 26 into the first (closed) position. The length of aerator latch springbar 26 is adapted to the diameter of the front wheel axle housing 18.

The movement of the aerator latch springbar 26 into the first (closed) position causes the aerator latch springbar 26 to create, in concert with the U-shaped bars 12, a space that accommodates the front wheel axle housing 18, thereby “capturing” the axle housing 18 into a constrained space. Capturing the axle housing 18 minimizes lateral movement of the axle housing 18 against the tow bar 2 and consequently minimizes the lateral movement of the aerator 4 during transport over uneven terrain.

With reference to FIG. 1, the means 8 for attaching the tow bar 2 to the towing vehicle comprises a tow latch spring mechanism 36, which includes a tow latch housing 38, a tow latch springbar 40 attached to a tow latch handle 42 and a tow latch spring 44 that is coiled around tow latch springbar 40. A tow latch spring stop 46 limits the travel of the tow latch springbar 40 and transmits force from the tow latch housing 38 to the tow latch springbar 40.

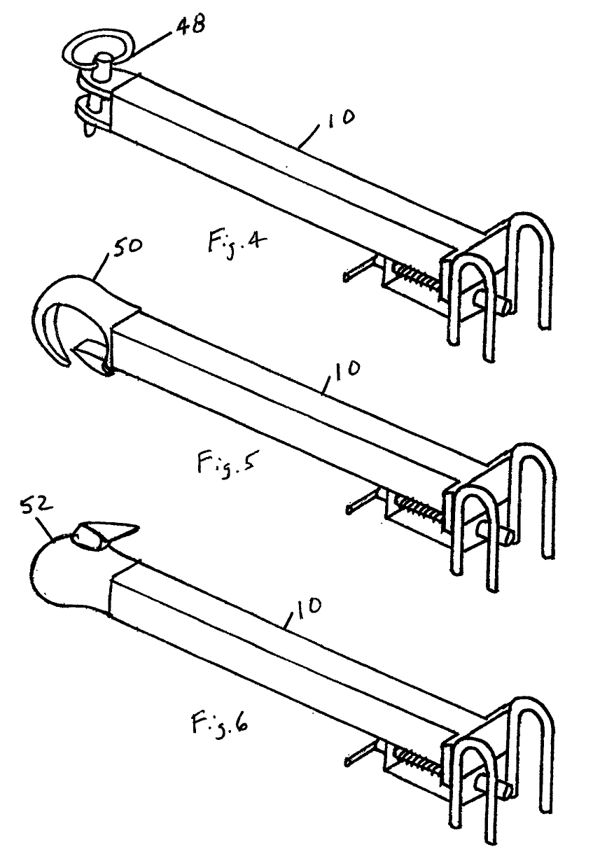

The tow latch springbar 40 is initially in a first (closed) position. To mount the tow bar 2 to a towing vehicle, tow latch handle 42 is pulled, thereby urging tow latch spring stop 46 against tow latch spring 44, compressing tow latch spring 44 and retracting tow latch springbar 40 to a second (open) position. The tow latch housing 38 then is placed in mating apposition to a hitch of a towing vehicle (not shown). The tow latch handle 42 is released, allowing the tow latch spring 44 to urge the tow latch springbar 40 back into the first (closed) position. As the tow latch springbar 40 returns to the closed position, the tow latch springbar 40 passes through a mating hole in the hitch of the towing vehicle, securing the tow bar 2 to the towing vehicle. A clevis pin 48, hook 50, trailer hitch 52 (FIGS. 4 through 6) or any suitable mechanism can be substituted for the tow latch spring 44 and tow latch springbar 40 for connection of the tow bar 2 to the towing vehicle.

With reference to FIG. 3, the invention includes a method for aerating a golf course using a self-propelled aerator 4 and a towing vehicle, which includes the following steps:

(1) Operating the aerator is a self-propelled manner to aerate a desired area of a golf course;

(2) providing a tow bar as described above;

(3) removably securing the tow bar to the front wheel axle housing of the self-propelled aerator and to a towing vehicle;

(4) driving the towing vehicle with the secured self-propelled aerator to another grassy area in the golf course, which is desired to be aerated;

(5) removing the tow bar between the self-propelled aerator and the towing vehicle;

(6) operating the aerator in a self-propelled manner to aerate the grassy area.

Many different embodiments of the above invention are possible. This application is intended to address all possible embodiments and is limited only as described in the following claims.

I claim:

1. A vehicle tow bar comprising:
a. a cross member;
b. means to connect said cross member to a vehicle to be towed;
c. means to connect said cross member to a towing vehicle.

2. The vehicle tow bar of claim 1, said vehicle to be towed having an axle housing, further comprising said means for connecting said cross member to said vehicle to be towed comprising a pair of U-shaped members affixed to said tow bar, said U-shaped members defining an axle-receiving opening, said axle-receiving opening being adapted to receive said axle housing of said vehicle to be towed.

3. The vehicle tow bar of claim 2 further comprising said U-shaped members having a curved portion, said U-shaped members being adapted so that said curved portion rests on said axle housing.

4. The vehicle tow bar of claim 3, said vehicle to be towed having at least two front wheels connected by said axle housing, said U-shaped members being adapted to engage said axle housing between said at least two front wheels.

5. The vehicle tow bar of claim 4, further comprising means to retain said axle housing within said axle receiving opening.

6. The vehicle tow bar of claim 5, said means to retain said axle housing within said axle receiving opening comprising a spring mechanism.

7. The vehicle towing bar of claim 6, said spring mechanism comprising:
a. a towed vehicle latch springbar;
b. a towed vehicle latch spring releasably urging said towed vehicle latch springbar into a position blocking said axle receiving opening whereby said axle housing is retained within said axle receiving opening.

8. The vehicle towing bar of claim 7, said vehicle being a self-propelled aerator.

9. The vehicle towing bar of claim 8, said means for connecting said towing bar to said towing vehicle comprising a tow latch spring mechanism attached to said tow bar and releasably engaging said towing vehicle.

10. The vehicle towing bar of claim 9, said tow latch spring mechanism comprising:
a. a tow latch housing attached to said tow bar;
b. a tow latch springbar slidably engaging said tow latch housing;
c. a tow latch spring coiled around said tow latch springbar and releasably urging said tow latch springbar through a mating hole on a towing hitch of a towing vehicle.

11. The vehicle towing bar of claim 8, said means for attaching said tow bar to said towing vehicle comprising a clevis pin, hook or trailer hitch.

12. A method for towing a vehicle comprising the steps of:
a. releasably attaching an axle housing of a towed vehicle to a tow bar having two U-shaped members, said two U-shaped members defining an axle-receiving opening, said axle receiving opening being adapted to receive and hold said axle housing;
b. releasably attaching said tow bar to a towing vehicle;
c. moving said towing vehicle while said tow bar is attached to said towing vehicle and said towed vehicle.

13. The method of claim 12, said towed vehicle being a self-powered aerator.

14. A method for aerating a golf course comprising the following steps:
a) operating the aerator in a self-propelled manner to aerate a desired area of a golf course;
b) removably securing a tow bar to the front wheel axle housing of the self-propelled aerator and to a towing vehicle;
c) driving the towing vehicle with the secured self-propelled aerator to another grassy area in the golf course, which is desired to be aerated;
d) removing the tow bar between the self-propelled aerator and the towing vehicle;
e) operating the aerator in a self-propelled manner to aerate the grassy area.
